(19) United States
(12) Patent Application Publication
(10) Pub. No.: US 2013/0029110 A1
(43) Pub. Date: Jan. 31, 2013

(54) Natural Cured Coating Composition, Product and Method of Producing the Same

(71) Applicant: Siri Chakka, (US)

(72) Inventor: Siri Chakka, (US)

(21) Appl. No.: 13/191,434

(22) Filed: Jul. 26, 2011

(51) Int. Cl. B32B 3/00; C09D 191/00

(52) U.S. Cl. 428/195.1; 106/251

(57) ABSTRACT

Methods, products and a composition are provided which relate to non-toxic and biodegradable cured coatings. The cured coatings cure under ambient conditions with a reduced cure time, have no VOC emissions upon curing, and have little or no VOC emissions during curing.

### CROSS-REFERENCE TO RELATED APPLICATIONS

Not applicable.

### BACKGROUND OF THE INVENTION

The present invention generally relates to cured coating products having dry erase properties. More particularly, the present invention relates to a natural cured coating product having dry erase properties.

Paints are generally known in the field. Paints contain three main components: a pigment, a film-former or binder, and a liquid carrier. Writeable and erasable surfaces known commonly as “dry erase” boards or “whiteboards” are also generally known in the field. Such boards typically include a substrate and a coating, the surface of which can be marked using dry erase marking pens and erased with minimal effort.

Goscha, US Patent Application Publication 2009/0148603 teaches water-based coatings having writable-erasable surfaces and methods of producing the same. The coatings taught by Goscha cure under ambient conditions. Goscha teaches forming the coatings from materials including one or more functional groups selected from G1 and G2 functional groups. The G1 functional group is taught to contain isocyanate, epoxide, urethane, ethyleneoxy and ethylene. The G2 functional group is taught to contain hydroxyl, amine, phenol, carboxylic acid, acid anhydride, aziridine and thiol.

Goscha teaches coatings having, at the low end, from about 0 g/L to about 50 g/L of volatile organic compounds (VOCs). Goscha additionally teaches coatings that are substantially free of VOCs and the use of VOCs that are exempted from the United States Environmental Protection Agency Guidelines such as isopropyl alcohol or acetone.

Goscha teaches coatings having a cure time, under ambient conditions, of from about 1 day to 7 days on the high end and from about 4 hours to about 24 hours on the low end. In addition, Goscha teaches coatings that are part of both a one-pot and a two-pot system. Finally, Goscha teaches coatings that can be applied to many different types of substrates.

Goscha does not teach water-based coatings having writeable-erasable surfaces that are non-toxic and biodegradable. Goscha does not teach coatings that have 0 g/L of VOCs. Goscha does not teach coatings that have consistently shortened cure times.

Foster, et al., U.S. Pat. No. 5,320,670, teaches nontoxic and bioreducible paint that is predominantly vegetable oil and preferably soybean oil. Foster teaches paints having a drying time of about at least one hour and no more than about 5 months. Foster does not teach paints having dry erase properties.

### BRIEF SUMMARY OF THE INVENTION

One or more of the embodiments of the present invention provide cured coating compositions including the following non-toxic and biodegradable materials: water, soybean oil, a whitening agent; flaxseed oil; aluminum silicate; a calcium based metallic dryer, and a hardening agent selected from the group consisting of shellac and epoxidized soybean oil. One or more embodiments of the present invention provide a cured coating composition capable of being extended upon a substrate, curable under ambient conditions, and, after being marked with a marking material, the marking can be erased to be substantially invisible.

One or more embodiments of the present invention provide a non-toxic and biodegradable cured coating product produced by blending the following materials: water, soybean oil, a whitening agent; flaxseed oil; aluminum silicate; a calcium based metallic dryer, and epoxidized soybean oil.

One or more embodiments of the present invention provide a non-toxic and biodegradable cured coating product produced by blending the following materials: water, soybean oil, a whitening agent; flaxseed oil; aluminum silicate; and a calcium based metallic dryer to form an initial uncured coating mixture. One or more embodiments of the present invention provide dissolving shellac in a denatured alcohol to form a solubilized shellac hardening agent. One or more embodiments of the present invention provide mixing the initial uncured coating mixture into the solubilized shellac hardening agent to form the cured coating product.

One or more embodiments of the present invention provide a method for producing a cured coating product using an epoxidized soybean oil hardening agent.

One or more embodiments of the present invention provide a method for producing a cured coating product using a shellac hardening agent.

### BRIEF DESCRIPTION OF THE DRAWINGS

FIG. 1 illustrates a flow chart for an embodiment of a method for producing a cured coating product with epoxidized soybean oil

FIG. 2 illustrates a flow chart for an embodiment of a method for producing a cured coating product with shellac.

FIG. 3 illustrates a flowchart for an embodiment of a method for producing a cured coating surface with a shellac hardening agent.

FIG. 4 illustrates a flowchart for an embodiment of a method for producing a cured coating surface with an epoxidized soybean oil hardening agent.

### DETAILED DESCRIPTION OF THE INVENTION

The present invention generally relates to cured coating products having dry erase properties. More particularly, the present invention relates to a natural cured coating product having dry erase properties. The compositions described here include, but are not limited to, non-toxic, biodegradable cured coating compositions having the components listed in Table 1:

TABLE 1
Component

Water
Soybean oil resin
A whitening agent
Flaxseed oil
Aluminum silicate
Thistle oil
Metallic dryer
Hardening agent

### DEFINITIONS

The term “non-toxic” is used herein to describe substances, products, compositions, and components that are not producing or resulting from a poison or toxin.

The term “biodegradable” is used herein to describe substances, products, compositions, and components that are capable of being decomposed by biological means.

The term “natural” is used herein to describe substances, products, compositions, and components that are both non-toxic and biodegradable.

The term “cured coating” is used herein to describe coatings that have been imparted onto a substrate, cured, and have writeable and erasable properties.

The term “cure” as used herein refers to the act of solvent evaporation.

“Substantially invisible” as used herein refers to a color difference of as much as 5 dE, as calculated according to ASTM International.

“Ambient conditions” as used herein refers to conditions as they exist at sea level at a temperature of about 45-130° F.

### Composition Descriptions

One or more embodiments of the present invention contain water. One or more embodiments of the present invention contain water in a final uncured coating mixture from 12 wt % to 23 wt %, preferably 15 wt %. to 20 wt %.

One or more embodiments of the present invention contain soybean oil resin. One or more embodiments of the present invention contain soybean oil resin in a final uncured coating mixture from 12 wt % to 28 wt %, preferably 15 wt %. to 20 wt %. Any vegetable oil or animal fat resin may be used equally effectively.

One or more embodiments of the present invention contain a whitening agent. Suitable whitening agents for use in embodiments of the present invention include titanium dioxide, calcium carbonate, the mineral talc, and the clay kaolin. Preferably the whitening agent is titanium dioxide. One or more embodiments of the present invention contain titanium dioxide in a final uncured coating mixture from 12 wt % to 18 wt %, preferably 14 wt %. to 16 wt %.

One or more embodiments of the present invention contain a color pigment. Preferably the color pigment is non-toxic and biodegradable. Color pigments suitable for use in embodiments of the present invention include pigments manufactured by the Earth Pigments Company.

One or more embodiments of the present invention contain flaxseed oil. One or more embodiments of the present invention contain flaxseed oil in a final uncured coating mixture from 2 wt % to 13 wt %, preferably 5 wt %. to 10 wt %.

One or more embodiments of the present invention contain a wetting agent. Wetting agents suitable for use in embodiments of the present invention include nepheline syenite and soy lecithin. One or more embodiments of the present invention contain nepheline syenite in a final uncured coating composition from 2 wt % to 13 wt %, preferably 5 wt %. to 10 wt %. One or more embodiments of the present invention contain soy lecithin in a final uncured coating mixture from 2 wt % to 8 wt %, preferably 3 wt %. to 6 wt %.

One or more embodiments of the present invention contain aluminum silicate. One or more embodiments of the present invention contain aluminum silicate in a final uncured coating mixture from 2 wt % to 13 wt %, preferably 5 wt %. to 10 wt %.

One or more embodiments of the present invention contain thistle oil. One or more embodiments of the present invention contain thistle oil in a final uncured coating mixture from 2 wt % to 8 wt %, preferably 4 wt %. to 6 wt %.

One or more embodiments of the present invention include a metallic dryer. Preferably the metallic dryer is a calcium-based metallic dryer. Calcium-based metallic dryers suitable for use in embodiments of the present invention include calcium carbonate. One or more embodiments of the present invention contain calcium carbonate in a final uncured coating mixture from 2 wt % to 13 wt %, preferably 5 wt %. to 10 wt %.

One or more embodiments of the present invention contain a hardening agent. Hardening agents suitable for use in embodiments of the present invention include shellac, epoxidized soybean oil, and pine resin.

One or more embodiments of the present invention contain shellac in a final uncured coating composition from 17 wt % to 28 wt %, preferably 20 wt %. to 25 wt %.

In one or more embodiments of the present invention, the hardening agent is dissolved in a denatured alcohol. Denatured alcohols suitable for use in embodiments of the present invention include Klean-Strip Green, Sunnyside Corp., and Wm Barr & Company. Preferably the denatured alcohol used is Klean-Strip Green. The hardening agent should be dissolved in a 1:8 hardening agent to denatured alcohol weight ratio.

One or more embodiments of the present invention have a viscosity sufficient to prevent the final uncured coating mixture from running during application to a substrate or curing. One or more embodiments of the present invention contain a final uncured coating mixture having a viscosity between about 1500 m Pa s and about 2200 m Pa s, preferably the viscosity is between about 1800 m Pa s and about 2000 m Pa s.

### Method Descriptions

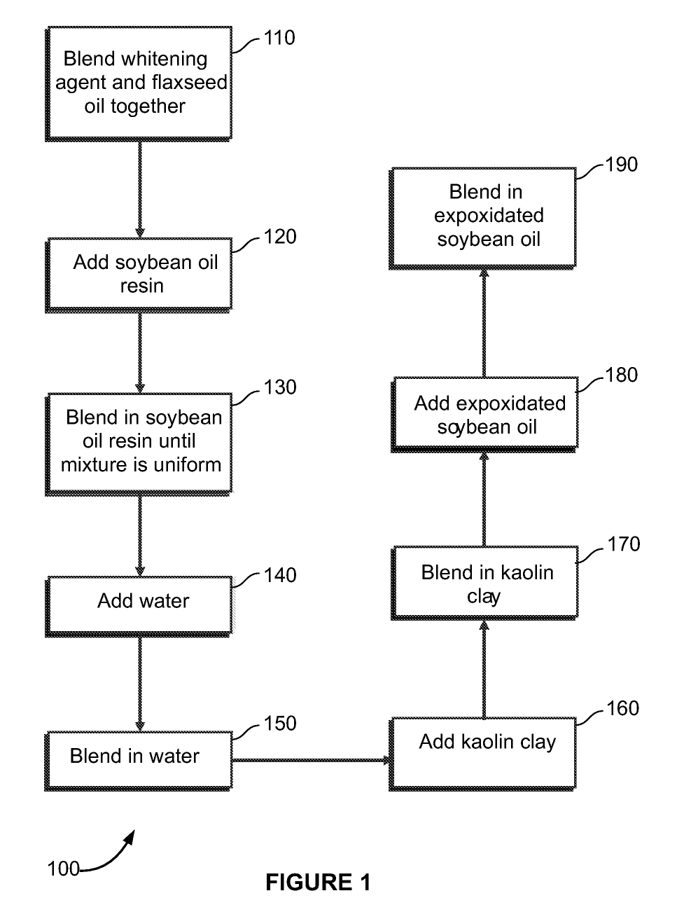

FIG. 1 illustrates a flow chart for a method of producing a cured coating product 100 according to an embodiment of the present invention.

First, at step 110, whitening agent and flaxseed oil are mixed together. The whitening agent and the flaxseed oil are blended together to form a first intermediate mixture. The blending occurs at slow speeds.

Next, at step 120, soybean oil resin is added to the first intermediate mixture.

At step 130, soybean oil resin is blended in until the mixture is uniform. The soybean oil resin is blended with increased speed until the mixture is of uniform consistency to form a second intermediate mixture.

At step 140, water is added to the second intermediate mixture.

At step 150, the water is blended in. The water is blended into the second intermediate mixture at slow speeds to form a third intermediate mixture.

At step 160, aluminum silicate is added to the third intermediate mixture.

At step 170, the aluminum silicate is blended in. The aluminum silicate is blended into the third intermediate mixture at slow speeds to form an initial uncured coating mixture.

At step 180, epoxidized soybean oil is added to the initial uncured coating mixture.

Finally, at step 190, the epoxidized soybean oil is blended in. The epoxidized soybean oil is stirred into the uncured coating mixture to form a final uncured coating mixture. Preferably the final uncured coating mixture has a viscosity sufficient to prevent the final uncured coating mixture from running during application to a substrate or curing. Preferably the viscosity is between about 1500 m Pa s and about 2500 m Pa s, more preferably the viscosity is between about 1800 m Pa s and about 2000 m Pa s.

In another embodiment, thistle oil is additionally blended with the whitening agent and the flaxseed oil to form the first intermediate mixture at step 110.

In another embodiment, the whitening agent in step 110 is titanium dioxide.

In another embodiment, a wetting agent is additionally added with the aluminum silicate at step 170 and blended at step 180 to form the initial uncured coating mixture.

In another embodiment, the wetting agent added with the aluminum silicate at step 170 and blended at step 180 to form the initial uncured coating mixture is nepheline syenite.

In another embodiment, the wetting agent added with the aluminum silicate at step 170 and blended at step 180 to form the initial uncured coating mixture is soy lecithin.

In another embodiment, a metallic dryer is added with the aluminum silicate at step 170 and blended at step 180 to form the initial uncured coating mixture.

In another embodiment, the metallic dryer added with the aluminum silicate at step 170 and blended at step 180 to form the initial uncured coating mixture is a calcium based metallic dryer.

In another embodiment, the metallic dryer added with the aluminum silicate at step 170 and blended at step 180 to form the initial uncured coating mixture is calcium carbonate.

In another embodiment, calcium carbonate and nepheline syenite are additionally added with the aluminum silicate at step 170 and blended at step 180 to form the initial uncured coating mixture.

In another embodiment, calcium carbonate and soy lecithin are additionally added with the aluminum silicate at step 170 and blended at step 180 to form the initial uncured coating mixture.

In another embodiment, the method for producing a cured coating product 100 has less than 5 g/L of volatile organic compounds, preferably less than 2 g/L of volatile organic compounds, most preferably 0 g/L of volatile organic compounds, none of these volatile organic compounds being hazardous.

In another embodiment, the step 110 includes blending a color pigment with the whitening agent and flaxseed oil to form the first intermediate mixture.

In another embodiment, the final uncured coating mixture formed at step 190 is stored in a suitable vessel known to those skilled in the art to allow the uncured coating mixture to remain uncured until imparted on a substrate and allowed to cure under ambient conditions.

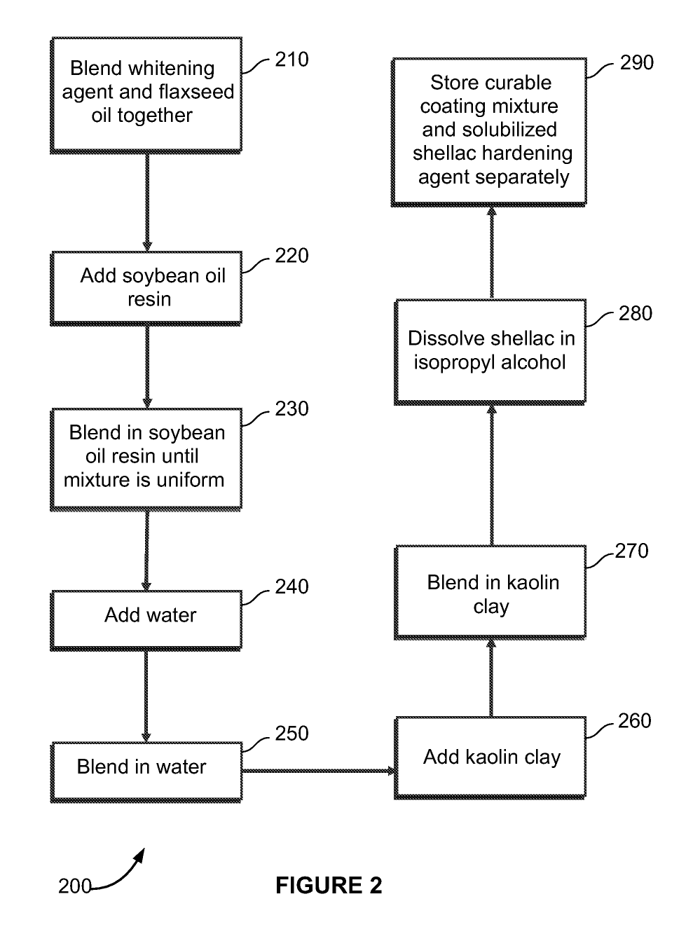

FIG. 2 illustrates a flow chart for a method of producing a cured coating product 200 according to an embodiment of the present invention.

First, at step 210, a whitening agent and flaxseed oil are mixed together. The whitening agent and the flaxseed oil are blended together to form a first intermediate mixture. The blending occurs at slow speeds.

Next, at step 220, soybean oil resin is added to the first intermediate mixture.

At step 230, soybean oil resin is blended in until the mixture is uniform. The soybean oil resin is blended with increased speed until the mixture is of uniform consistency to form a second intermediate mixture.

At step 240, water is added to the second intermediate mixture.

At step 250, the water is blended in. The water is blended into the second intermediate mixture at slow speeds to form a third intermediate mixture.

At step 260, aluminum silicate is added to the third intermediate mixture.

At step 270, the aluminum silicate is blended in. The aluminum silicate is blended into the third intermediate mixture at slow speeds to form an initial uncured coating mixture.

At step 290, shellac is dissolved in denatured alcohol to form a solubilized shellac hardening agent.

At step 280, the initial uncured coating mixture is stirred into the solubilized shellac hardening agent to form a final uncured coating mixture. Preferably the final uncured coating mixture has a viscosity sufficient to prevent the final uncured coating mixture from running during application to a substrate or curing. Preferably the viscosity is between about 1500 m Pa s and about 2200 m Pa s, more preferably the viscosity is between about 1800 m Pa s and about 2000 m Pa s.

In another embodiment, thistle oil is additionally blended with the whitening agent and the flaxseed oil to form the first intermediate mixture at step 210.

In another embodiment, the whitening agent in step 210 is titanium dioxide.

In another embodiment, a wetting agent is additionally added with the aluminum silicate at step 260 and blended at step 270 to form the initial uncured coating mixture.

In another embodiment, the wetting agent added with the aluminum silicate at step 260 and blended at step 270 to form the initial uncured coating mixture is nepheline syenite.

In another embodiment, the wetting agent added with the aluminum silicate at step 260 and blended at step 270 to form the initial uncured coating mixture is soy lecithin.

In another embodiment, a metallic dryer is added with the aluminum silicate at step 260 and blended at step 270 to form the initial uncured coating mixture.

In another embodiment, the metallic dryer added with the aluminum silicate at step 260 and blended at step 270 to form the initial uncured coating mixture is a calcium based metallic dryer.

In another embodiment, the metallic dryer added with the aluminum silicate at step 260 and blended at step 270 to form the initial uncured coating mixture is calcium carbonate.

In another embodiment, calcium carbonate and nepheline syenite are additionally added with the aluminum silicate at step 260 and blended at step 270 to form the initial uncured coating mixture.

In another embodiment, calcium carbonate and soy lecithin are additionally added with the aluminum silicate at step 260 and blended at step 270 to form the initial uncured coating mixture.

In another embodiment, the method for producing a cured coating product 200 has less than 5 g/L of volatile organic compounds, preferably less than 2 g/L of volatile organic compounds, most preferably 0 g/L of volatile organic compounds.

In another embodiment, the step 210 includes blending a color pigment with the whitening agent and flaxseed oil to form the first intermediate mixture.

In another embodiment, the final uncured coating mixture formed at step 290 is imparted on a substrate and allowed to cure under ambient conditions.

In another embodiment, the initial uncured coating mixture formed at step 270 and the solubilized shellac hardening agent formed at step 290 are stored in separate vessels known to those skilled in the art so as to allow the initial uncured coating mixture to remain uncured until step 290 is performed and the final uncured coating mixture is imparted on a substrate and allowed to cure under ambient conditions.

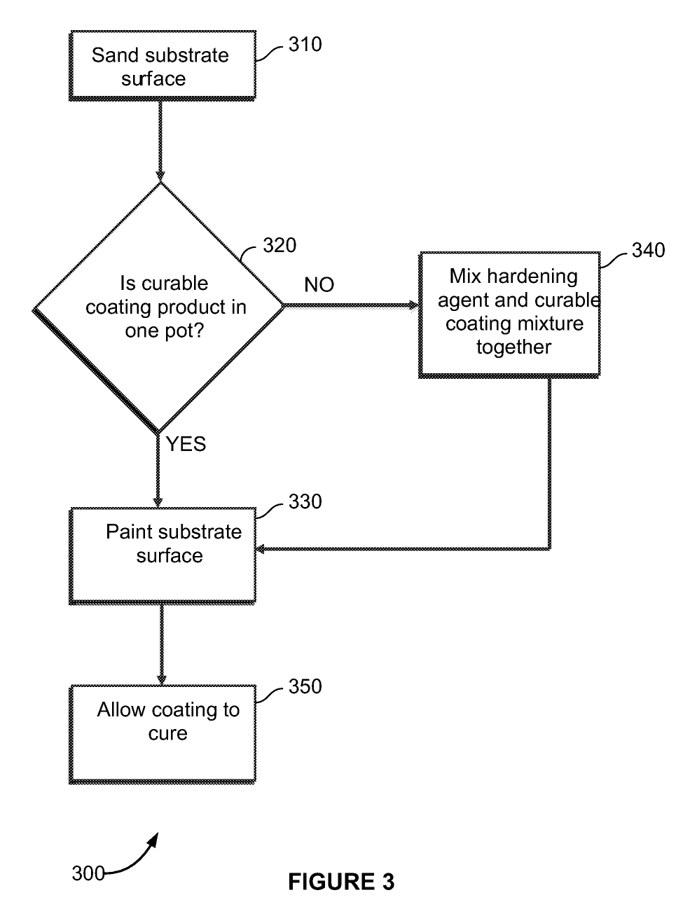

FIG. 3 illustrates a flow chart for a method for producing a cured coating product 300 according to an embodiment of the present invention.

First, at step 310 the surface is sanded to form a sanded surface.

Next, at step 320, the final uncured coating of step 280 of the method for producing a cured coating product 200 is imparted onto the sanded surface of step 310 using an instrument known to those skilled in the art.

At step 330, the uncured coating is allowed to cure for a cure time to form a cured coating surface. Preferably the cure time is less than 24 hours, preferably less than 18 hours, preferably less than 12 hours, preferably less than 8 hours, most preferably less than 6 hours.

At step 340, the cured coating surface is marked with a marking material.

Suitable marking materials include dry-erase markers.

Finally, at step 350, the marking material is erased. The marking material is erased so as to make the marking substantially invisible after marking. Steps 340 and 350 can then be repeated.

In another embodiment, the method for producing a cured coating product 300 has less than 5 g/L of volatile organic compounds during curing, preferably less than 2 g/L of volatile organic compounds, most preferably 0 g/L of volatile organic compounds.

In another embodiment the marking material of step 340 includes a colorant and a solvent. The solvent can include one or more of water, alcohols, alkoxy alcohols, ketones, ketonic alcohols, esters, acetates, mineral spirits, or mixtures thereof.

In another embodiment, suitable erasers for use in step 350 include fibrous materials known to those skilled in the art and/or one or more of water, alcohols, alkoxy alcohols, ketones, ketonic alcohols, esters, acetates or mineral spirits or mixtures thereof.

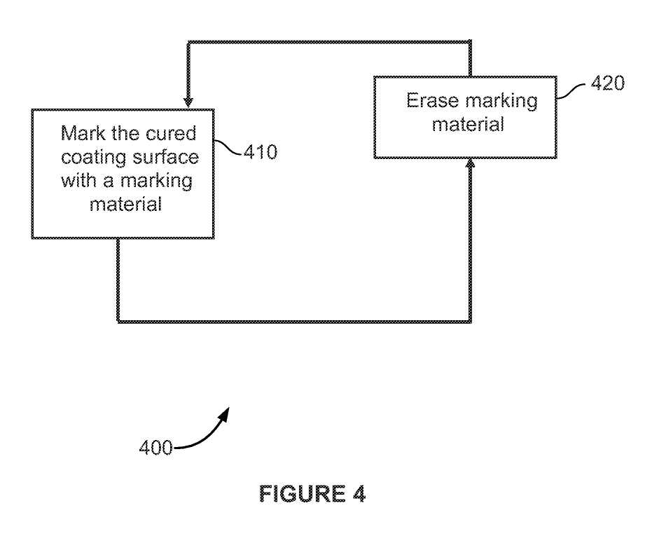

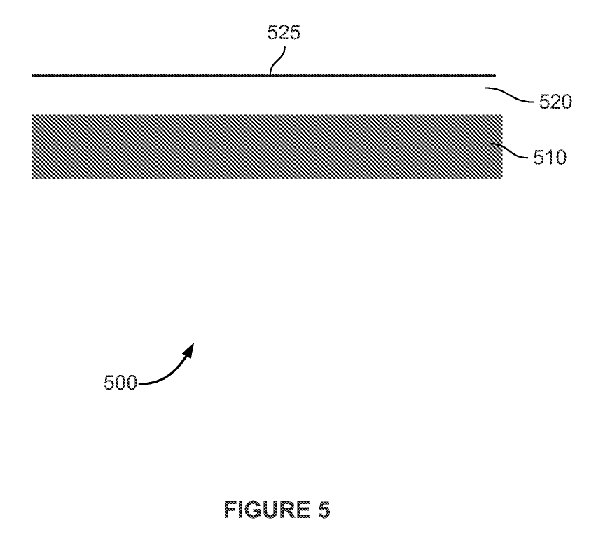

FIG. 4 illustrates a flow chart for a method for producing a cured coating product 400 according to an embodiment of the present invention.

First, at step 410, a surface is sanded. The surface is sanded to improve the properties of the cured coating product including the ease of application of the final uncured coating mixture to the surface, the marking of the

[symbol]

At step 460, the final uncured coating of step 190 of the method for producing a cured coating product 100 is mixed into the solubilized shellac hardening agent of step 290 of the method for producing a cured coating product 200.

Next, at step 420, the final uncured coating of step 190 of the method for producing a cured coating product 100 is imparted onto the sanded surface of step 310 using an instrument known to those skilled in the art.

At step 430, the uncured coating is allowed to cure for a cure time to form a cured coating surface. Preferably the cure time is less than 24 hours, preferably less than 18 hours, preferably less than 12 hours, preferably less than 8 hours, most preferably less than 6 hours.

At step 440, the cured coating surface is marked with a marking material. Suitable marking materials include

[symbol]

Finally, at step 450, the marking material is erased. The marking material is erased so as to make the marking substantially invisible after marking. Steps 440 and 450 can then be repeated.

In another embodiment, the method for producing a cured coating product 400 has less than 5 g/L of volatile organic compounds during curing, preferably less than 2 g/L of volatile organic compounds, most preferably 0 g/L of volatile organic compounds.

In another embodiment, the marking material of step 440 includes a colorant and a solvent. The solvent can include one or more of water, alcohols, alkoxy alcohols, ketones, ketonic alcohols, esters, acetates, mineral spirits, or mixtures thereof.

In another embodiment, suitable erasers for use in step 450 include fibrous materials known to those skilled in the art and/or one or more of water, alcohols, alkoxy alcohols, ketones, ketonic alcohols, esters, acetates or mineral spirits or mixtures thereof.

### EXAMPLES

The compositions and processes described here, and ways to make and use them are illustrated by the following examples. Examples stated in the present or future tense are not represented as having been carried out.

### Example 1

### Preparation of A Cured Coating Product Using Shellac Hardening Agent

During the first blending stage, to the pot were added, in order, in the ranges of weight % listed in Table 2, flaxseed oil, thistle oil and titanium dioxide. The contents were then blended at slow speeds until fully dispersed to form a first intermediate mixture. During the second blending stage, soybean oil resin was then added to the mixture in the pot. The mixing speed is increased and the mixture in the pot blended for 5-10 minutes until the mixture in the pot was of uniform consistency to form a second intermediate mixture. During the third blending stage, water was added to the mixture in the pot. The contents were then blended at slow speeds until fully dispersed to form a third intermediate mixture. During the fourth blending stage, aluminum silicate was added to the mixture in the pot. The mixture in the pot is then blended at slow speeds until fully dispersed to form an uncured coating mixture. The temperature of the mixture in the pot was maintained at 65-75° F. during and after blending.

In a second pot, in order, in the ranges of weight % listed in Table 2, to the pot are added, 5 wt % ethanol and shellac. The contents of the pot were blended until the shellac was completely dissolved to form a solubilized hardening agent.

During the final blending stage, the uncured coating mixture was added to the solubilized hardening agent. The pot was stirred with a spatula until the contents of the pot were fully dispersed to form a final uncured coating mixture.

The surface of a pine wood board was sanded until substantially free of imperfections. The final uncured coating mixture was painted on to the pine wood board surface. The coating took 4-8 hours to cure under ambient temperature and pressure and form a cured coating product. The alcohol completely evaporated in less than 30 minutes.

TABLE 2
Shellac Formulation

| Component | Range % by wt of formula |
|---|---|
| Shellac | 20-23 |
| Water | 15-20 |
| Soybean oil resin | 15-20 |
| Titanium Dioxide | 15 |
| Flaxseed Oil | 5-10 |
| Aluminum Silicate | 5-10 |
| Thistle Oil | 5 |

### Example 2

### Preparation of Cured Coating Composition Using Shellac And Nepheline Syenite

During the first blending stage, to the pot were added, in order, in the ranges of weight % listed in Table 3, flaxseed oil, thistle oil and titanium dioxide. The contents were then blended at slow speeds until fully dispersed to form a first intermediate mixture. During the second blending stage, soybean oil resin was then added to the mixture in the pot. The mixing speed is increased and the mixture in the pot blended for 5-10 minutes until the mixture in the pot was of uniform consistency to form a second intermediate mixture. During the third blending stage, water was added to the mixture in the pot. The contents were then blended at slow speeds until fully dispersed to form a third intermediate mixture. During the fourth blending stage, aluminum silicate, calcium carbonate, and nepheline syenite were added to the mixture in the pot. The mixture in the pot is then blended at slow speeds until fully dispersed to form an uncured coating mixture. The temperature of the mixture in the pot was maintained at 65-75° F. during and after blending.

In a second pot, in order, in the ranges of weight % listed in Table 2, to the pot are added, 5_wt % ethanol and shellac. The contents of the pot were blended until the shellac was completely dissolved to form a solubilized hardening agent.

During the final blending stage, the uncured coating mixture was added to the solubilized hardening agent. The pot is stirred with a spatula until the contents of the pot were fully dispersed to form a final uncured coating mixture.

The surface of a pine wood board was sanded until substantially free of imperfections. The final uncured coating mixture was painted on to the pine wood board surface. The coating took 4-8 hours to cure under ambient temperature and pressure and form a cured coating product. The alcohol completely evaporated in less than 30 minutes.

TABLE 3
Nepheline Syenite Formulation

| Component | Range % by wt of formula |
|---|---|
| Shellac | 20 |
| Soybean oil resin | 20-25 |
| Water | 15-20 |
| Titanium dioxide | 15 |
| Calcium carbonate | 5-10 |
| Nepheline Syenite | 5-10 |
| Flaxseed oil | 5-10 |
| Aluminum silicate | 5 |
| Thistle Oil | 5 |

### Example 3

### Preparation of Cured Coating Composition Using Shellac And Soy Lecithin

During the first blending stage, to the pot were added, in order, in the ranges of weight % listed in Table 3, flaxseed oil, thistle oil and titanium dioxide. The contents were then blended at slow speeds until fully dispersed to form a first intermediate mixture. During the second blending stage, soybean oil resin was then added to the mixture in the pot. The mixing speed is increased and the mixture in the pot blended for 5-10 minutes until the mixture in the pot was of uniform consistency to form a second intermediate mixture. During the third blending stage, water was added to the mixture in the pot. The contents were then blended at slow speeds until fully dispersed to form a third intermediate mixture. During the fourth blending stage, aluminum silicate, calcium carbonate, and soy lecithin were added to the mixture in the pot. The mixture in the pot is then blended at slow speeds until fully dispersed to form an uncured coating mixture. The temperature of the mixture in the pot was maintained at 65-75° F. during and after blending.

In a second pot, in order, in the ranges of weight % listed in Table 2, to the pot are added, 5 wt % ethanol and shellac. The contents of the pot were blended until the shellac was completely dissolved to form a solubilized hardening agent.

During the final blending stage, the uncured coating mixture was added to the solubilized hardening agent. The pot is stirred with a spatula until the contents of the pot were fully dispersed to form a final uncured coating mixture.

The surface of a pine wood board was sanded until substantially free of imperfections. The final uncured coating mixture was painted on to the pine wood board surface. The coating took 4-8 hours to cure under ambient temperature and pressure and form a cured coating product. The alcohol completely evaporated in less than 30 minutes.

TABLE 4
Soy Lecithin Formulation

| Component | Range % by wt of formula |
|---|---|
| Shellac | 25 |
| Soybean oil resin | 20-25 |
| Water | 15-20 |
| Calcium Carbonate | 5-10 |
| Titanium Dioxide | 15 |
| Flaxseed Oil | 5-10 |
| Aluminum Silicate | 5 |
| Soy Lecithin | 5 |

In view of the preceding teaching, embodiments of the present invention produce numerous advantages over known cured coating products, compositions and methods of producing the same. Importantly, the disclosed compositions, products and methods provide for cured coatings that are both non-toxic and biodegradable.

Additionally, one or more embodiments of the present invention have 0 g/L of VOCs during and after curing. One or more embodiments of the present invention have 0 g/L of VOCs after curing and from about 10 g/L to about 25 g/L of VOCs during curing.

Finally, one or more embodiments of the present invention have lessened cure times of from about less than 4 hours to about less than 24 hours, preferably from about less than 4 hours to about less than 6 hours.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A cured coating composition comprising:
water;
soybean oil;
a whitening agent;
flaxseed oil;
aluminum silicate;
a calcium based metallic dryer;
a hardening agent selected from the group consisting of shellac and epoxidized soybean oil; and
wherein said cured coating composition extends upon a substrate;
wherein said cured coating composition is curable under ambient conditions for a cure time to form a cured coating;
wherein, after said cured coating is marked with a marking material comprising a colorant and a solvent, said marking material can be erased from said cured coating to be substantially invisible;
wherein said cured coating composition is biodegradable; and
wherein said cured coating composition is non-toxic.

2. The composition of claim 1, additionally comprising:
a color pigment.

3. The composition of claim 1, additionally comprising:
thistle oil.

4. The composition of claim 1, wherein said whitening agent is titanium dioxide.

5. The composition of claim 1, wherein said cure time is less than 6 hours.

6. The composition of claim 1, wherein said solvent comprises one or more of water, alcohols, alkoxy alcohols, ketones, ketonic alcohols, esters, acetates, mineral spirits, or mixtures thereof.

7. The composition of claim 1, wherein said cured coating composition has 0 g/L of volatile organic compounds.

8. A cured coating product comprising:
providing the following ingredients:
a whitening agent and flaxseed oil;
blending said whitening agent and said flaxseed oil to form a first intermediate mixture;
adding soybean oil resin to said first intermediate mixture and blending until uniform to form a second intermediate mixture;
adding water to said second intermediate mixture and blending to form a third intermediate mixture;
adding aluminum silicate to said third intermediate mixture and blending to form an uncured coating mixture;
adding epoxified soybean oil to said uncured coating mixture and blending to form a final uncured coating mixture;
extending said final uncured coating mixture upon a substrate;
curing said final uncured coating mixture under ambient conditions for a cure time to form a cured coating product;
marking said cured coating product with a marking material comprising a colorant and a solvent;
wherein said marking material can be erased from said cured coating product to be substantially invisible;
wherein said cured coating product is non-toxic; and
wherein said cured coating product is biodegradable.

9. The cured coating product of claim 8, further including:
adding a color pigment.

10. The cured coating product of claim 8, further including:
adding thistle oil.

11. The cured coating product of claim 8, wherein said whitening agent is titanium dioxide.

12. The cured coating product of claim 8, wherein said cure time is less than 6 hours.

13. The cured coating product of claim 8, wherein said solvent of said marking material comprises one or more of water, alcohols, alkoxy alcohols, ketones, ketonic alcohols, esters, acetates, mineral spirits, or mixtures thereof.

14. The cured coating product of claim 8, wherein said cured coating product has 0 g/L of volatile organic components.

15. A cured coating product comprising:
providing the following ingredients:
a whitening agent and flaxseed oil;
blending said whitening agent and said flaxseed oil to form a first intermediate mixture;
adding soybean oil resin to said first intermediate mixture and blending until uniform to form a second intermediate mixture;
adding water to said second intermediate mixture and blending to form a third intermediate mixture;
adding aluminum silicate to said third intermediate mixture and blending to form an uncured coating mixture.
dissolving shellac in a denatured alcohol to form a solubilized shellac hardening agent;
mixing said final uncured coating mixture in said solubilized shellac hardening agent to form a final uncured coating mixture;
extending said final uncured coating mixture upon a substrate;
curing said final uncured coating mixture under ambient conditions for a cure time to form a cured coating product;
marking said cured coating product with a marking material comprising a coldrant and a solvent;
wherein said marking material can be erased from said cured coating product to be substantially invisible;
wherein said denatured alcohol evaporates after said final uncured coating mixture is mixed in said solubilized shellac hardening agent;
wherein said cured coating product is non-toxic; and
wherein said cured coating product is biodegradable.

16. The cured coating product of claim 15, additionally comprising:
adding a color pigment.
